(19) United States
(12) Patent Application Publication
(10) Pub. No.: US 2021/0003166 A1
(43) Pub. Date: Jan. 7, 2021

(54) OLIVE-SHAPED BIDIRECTIONAL TAPERED THREAD BOLT AND NUT CONNECTION STRUCTURE HAVING LARGE LEFT TAPER AND SMALL RIGHT TAPER

(71) Applicant: AMICUS VERITATIS MACHINERY CO., LTD., Taizhou (CN)

(72) Inventor: Yihua YOU, Taizhou (CN)

(21) Appl. No.: 17/031,236

(22) Filed: Sep. 24, 2020

Related U.S. Application Data
(63) Continuation of application No. PCT/CN2019/081370, filed on Apr. 4, 2019.

(30) Foreign Application Priority Data
Apr. 7, 2018 (CN) 201810303107.1

(51) Int. Cl. F16B 35/04

(52) U.S. Cl. CPC F16B 35/047

(57) ABSTRACT

The disclosure belongs to the technical field of general technology of devices, and relates to an olive-shaped bidirectional tapered thread bolt and nut connection structure having a large left taper and a small right taper, solving the problems of poor self-positioning and self-locking performances of the existing threads. An inner thread (6) is a bidirectional tapered hole (41) on the inner surface of the cylindrical body (2), an external thread (9) is a bidirectional truncated cone body (71) on the outer surface of a columnar body (3), the complete unit threads are both helical olive-like (93) shaped bidirectional tapered bodies which have larger left taper (95) being than right taper (96), and are large in the middle and small in two ends. The performance mainly depends on conical surfaces and tapers of mutually fit thread bodies.

### CROSS-REFERENCE TO RELATED APPLICATIONS

This application is a continuation of International Patent Application No. PCT/CN2019/081370 with a filing date of Apr. 4, 2019, designating the United States, now pending, and further claims priority to Chinese Patent Application No. 201810303107.1 with a filing date of Apr. 7, 2018. The content of the aforementioned applications, including any intervening amendments thereto, are incorporated herein by reference.

### TECHNICAL FIELD

The disclosure belongs to the field of general technology of devices, and particularly relates to an olive-shaped bidirectional tapered thread bolt and nut connection structure having a large left taper and a small right taper, namely a bolt and nut connection structure of an olive-like (left taper is larger than right taper) shaped asymmetric bidirectional tapered thread (hereinafter referred to as “bolt and nut of bidirectional tapered thread”).

### BACKGROUND OF THE PRESENT INVENTION

The invention of threads has a profound impact on the progress of human society. The thread is one of the most basic industrial technologies. It is not a specific product, but a key common technology in the industry. Its technical performance must be embodied by using the specific product as an application carrier, and the thread is widely used in all walks of life. The existing thread technology has a high standardization level, a mature technological theory and long-term practical application. If being used to fasten, the thread is a fastening thread; if being used to seal, the thread is a seal thread; if being used to drive, the thread is a transmission thread. According to thread terms in national standard: “thread” refers to tooth bodies having the same tooth shape and continuously protruded along a helical line on the cylindrical or conical surface; “tooth body” refers to a material entity between adjacent tooth sides. This is a definition of a thread that is globally agreed.

Modern threads are derived from Whitworth threads in England in 1841. According to the theory of the modern thread technology, the basic self-locking condition of the thread is that an equivalent friction angle should not be less than a lead angle. This is an understanding of the modern thread on the thread technology based on its technical principle-“bevel principle”, and has become an important theoretical basis for the modern thread technology. Steven theoretically explained the bevel principle at the earliest, he studied and found object balance conditions on the bevel and a parallelogram law of force synthesis. In 1586, he put forward a famous bevel law: the gravity of an object placed on the bevel along the bevel direction is proportional to the sine of the inclined angle. The bevel refers to a smooth plane which is inclined to a horizontal plane. The helical surface is the deformation of the “bevel”. The thread is like the bevel wrapped outside the cylindrical body, the smoother the bevel is, the greater the mechanical benefits are (see FIG. 7) (Jingshan Yang, Xiuya Wang, Discussion On The Principle Of Screws, Gauss Arithmetic Research).

The “bevel principle” of the modern thread is a bevel slider model established based on a bevel law (see FIG. 8). It is believed that under the conditions of static load and little temperature change, when the lead angle is less than or equal to the equivalent friction angle, a thread pair has self-locking conditions. The lead angle (see FIG. 9) is also known as a thread lead angle, namely an included angle between the tangent line of the helical line on a cylinder having a middle diameter and a plane perpendicular to the thread axis, which affects the self-locking and loosening prevention of the thread. The equivalent friction angle is a corresponding friction angle when different friction forms are finally transformed into the most common bevel slider form. Generally speaking, in a bevel slider model, when the bevel is inclined to a certain angle, the frictional force of the slider at this moment is just equal to the component of gravity along the bevel. At this moment, the object is just in a stress balance state. At this moment, the inclined angle of the bevel is called the equivalent friction angle.

American engineers invented a wedge-shaped thread in the middle of last century, and its technical principle still followed the “bevel principle”. The invention of the wedge-shaped thread is inspired by “wood wedge”. Specifically, the structure of the wedge-shaped thread has a wedge-shaped bevel which has an included angle of 25°˜30° with the thread axis at the tooth bottom of the internal thread (i.e., nut thread) of the triangular thread (commonly known as common thread). In engineering practice, 30° wedge-shaped bevel is actually used. For along time, people study and solve the problem of thread loosening prevention from the technical level and technical direction namely thread tooth profile angles. The wedge-shaped thread technology is no exception, which is a specific application of a wedge technology.

However, the existing thread has the problems of low connection strength, weak self-positioning capability, poor self-locking property, small bearing strength value, poor stability, poor compatibility, poor reusability, high temperature and low temperature and the like. Typical problems are that bolts or nuts using the modern thread technology have the defect of easy loosening. With the frequent vibration or shaking of the equipment, the bolts and nuts are loosened or even fall off, seriously, safety accidents easily occur.

### SUMMARY OF PRESENT INVENTION

Any technical theory has its theoretical assumption background, and there is no exception for threads. With the scientific and technical development, connection destruction is not pure linear load, even non-static and non room-temperature environment. There are linear loads, nonlinear loads and even the superposition of the linear loads and nonlinear loads, resulting in more complex failure loads with complex application work condition. Based on this understanding, aiming at the above problems, the objective of the disclosure is to provide a bolt and nut connection structure of a bidirectional tapered thread, which is reasonable in design, simple in structure and good in connection performance and locking performance.

In order to achieve the above objective, the disclosure adopts the following technical solution: the bolt and nut connection structure of the olive-like (left taper is larger than right taper) shaped asymmetric bidirectional tapered thread is used by a fact that an asymmetric bidirectional tapered thread internal thread and an asymmetric bidirectional thread external thread constitute a thread connection pair, and is a special thread pair technology combining technical features of cone pairs and helical movement. The bidirectional tapered thread is a thread technology combining technical features of a bidirectional tapered body and a helical structure. The bidirectional tapered body is composed of two single tapered bodies, that is, is bi-directionally composed of two single tapered bodies having opposite left and right taper directions and having the taper of the left tapered body being larger than that of the right tapered body. The bidirectional tapered body is helically distributed on the outer surface of the columnar body to form the external thread and/or the above bidirectional tapered body is helically distributed on the inner surface of the cylindrical body to form the internal thread. No matter which the internal thread or the external thread, its complete unit thread is an olive-like shaped special bidirectional tapered geometry which is large in the middle and small in two ends and has a left taper being larger than a right taper.

In the bolt and nut of the bidirectional tapered thread, the olive-like shaped asymmetric bidirectional tapered thread can be defined as “the cylindrical or conical surface has an asymmetric bidirectional tapered hole (or asymmetric bidirectional truncated cone body) having specified left taper and right taper, opposite left taper and right taper directions and left taper being larger than right taper, and a helical olive-like shaped special bidirectional tapered geometry which is distributed continuously and/or discontinuously along the helical line and is large in the middle and small in two ends”. For reasons such as manufacturing, the head and the tail of the asymmetric bidirectional tapered thread may be incomplete bidirectional tapered geometries. Different from the modern thread technology, the thread technology has been changed from an original engagement relationship between the internal thread and the external thread of the modern thread into a cohesion relationship between the internal thread and the external thread of the bidirectional tapered thread.

The bolt and nut of the bidirectional tapered internal thread includes a bidirectional truncated cone body helically distributed on the outer surface of the columnar body and a bidirectional tapered hole helically distributed on the inner surface of the cylindrical body, that is, the internal thread and the external thread which are in mutual thread fit, the internal thread is presented by a helical bidirectional tapered hole and exists in a form of “non-entity space”, and the external thread is presented by a helical special tapered body and exists in a form of “material entity”, the non-entity space refers to a space environment capable of accommodating the above material entity. The internal thread is a containing member, and the external thread is a contained member. The internal threads and the external threads are formed by screwing and sleeving bidirectional tapered geometries for cohesion pitch by pitch till bidirectional bearing at one side or simultaneous bidirectional bearing at left and right sides or till fixed-diameter interference fit, whether simultaneous bidirectional bearing occurs at two sides is related to actual application working conditions, that is, the bidirectional truncated cone bodies are contained in the bidirectional tapered holes pitch by pitch, that is, the internal threads are cohered with corresponding external threads pitch by pitch.

The thread connection pair is a thread pair formed by a cone pair constituted by mutual fit between a helical outer conical surface and a helical inner conical surface. The outer conical surface of the bidirectional tapered thread outer cone and the inner conical surface of the inner cone are both bidirectional conical surfaces. When the bidirectional tapered threads constitute the thread connection pair, the combination surface of the inner conical surface and the outer conical surface is used as a bearing surface, that is, the conical surface is used as the bearing surface to realize connection technical performance. The self-locking property, self-positioning property, reusability, fatigue resistance and other capabilities of the thread pair mainly depend on the conical surfaces and tapers of the cone pairs constituting the bolt and nut of the bidirectional tapered thread, namely the conical surfaces and tapers of the internal and external threads. The thread connection pair is a non-tooth thread.

Different from an unidirectional force distributed on the bevel and exhibited by the existing thread bevel principle and an engagement relationship between an internal tooth body and an external tooth body of the internal and external threads. For the bolt and nut of the bidirectional tapered thread, whether the thread body namely the bidirectional tapered body is distributed at the left side or the right side, when passing through the cross section of the cone axis, the single tapered body at any side is bi-directionally composed of two tessellation lines of the cone, namely in a bidirectional state. The tessellation line is an intersecting line formed by the conical surface and a plane through which the cone axis passes. An axial force and a counter-axial force are exhibited by the cone principle of the bolt and nut connection structure of the bidirectional tapered thread, and both of them are synthesized by bidirectional forces. The axial force and the corresponding counter-axial force are opposite, the internal thread and the external thread are in cohesion relationship, that is, when the thread pair is formed, the external thread is cohered by the internal thread, that is, tapered holes (inner cones) cohere corresponding tapered bodies (outer cones) till fixed-diameter fit so as to realize self positioning or till fixed-diameter interference fit contact so as to realize self locking, that is, self locking or self positioning of the inner cone and the outer cone is realized through cohesion of the tapered hole and the truncated cone body and then self locking or self positioning of the thread pair, rather than a fact that the thread connection pair is constituted by the internal thread and the external thread of the traditional thread through mutual abutment of tooth bodies to realize thread connection property.

A self-locking force can be generated when the cohesion process of the internal thread and the external thread reaches a certain condition. The self-locking force is generated by a pressure formed between the axial force of the inner cone and the counter-axial force of the outer cone, that is, when the inner cone and the outer cone constitute a cone pair, the inner conical surface of the inner cone coheres the outer conical surface of the outer cone, and the inner conical surface is in close contact with the outer conical surface. The axial force of the inner cone and the counter-axial force of the outer cone are concepts of a force which is unique to a bidirectional tapered thread technology namely a cone pair technology.

The inner cone exists in a form similar to a shaft sleeve. Under the action of foreign load, the inner cone body generates the axial force pointing to or pressing toward the cone axis. The axial force is bi-directionally synthesized by a pair of centripetal forces that are distributed in a mirror image with the cone axis as a center and respectively perpendicular to the two tessellation lines of the cone, that is, when passing through the cross section of the cone axis, the axial force is composed of two centripetal forces that are bi-directionally distributed at two sides of the cone axis in a form of mirror image with the cone axis as the center and respectively perpendicular to two tessellation lines of the cone and point to or press against the common point of the cone axis and when the above cone and the helical structure are synthesized into a thread and applied to the thread pair, when passing through the cross section of the thread axis, the above axial force is composed of two centripetal forces that are bi-directionally distributed at two sides of the thread axis in a form of mirror image and/or mirror-like image with the thread axis as the center and respectively perpendicular to the two tessellation lines of the cone and point to or press against the common point of the thread axis. The axial force is densely distributed on the cone axis and/or the thread axis in an axial and circumferential manner, the axial force corresponds to one axial force angle, the included angle of the two centripetal forces constituting the axial force constitutes the above axial force angle, and the axial force angle depends on the taper of the cone, namely a taper angle.

The outer cone exists in a form similar to a shaft, and has a strong ability to absorb various foreign loads. The outer cone generates a counter-axial force opposite to each axial force of the inner cone. The counter-axial force is bi-directionally synthesized by a pair of counter centripetal forces which are distributed in a mirror image with the cone axis as the center and respectively perpendicular to the two tessellation lines of the cone, that is, when passing through the cross section of the cone axis, the counter-axial force is composed of two counter centripetal forces which are bi-directionally distributed at two sides of the cone axis in a mirror image with the cone axis as the center and respectively perpendicular to the two tessellation lines of the cone or point to or press against the inner conical surface and when the above cone and the helical structure are synthesized into the thread and applied to the thread pair, when passing through the cross section of the thread axis, the above counter-axial force is composed of two counter centripetal forces which are bi-directionally distributed at two sides of the cone in a mirror image and/or mirror-like image with the thread axis as the center and respectively perpendicular to two tessellation lines of the cone and point to or press against the inner conical surface of the internal thread through the common points and/or similar common points of the cone axis. The counter-axial force is densely distributed on the cone axis and/or the thread axis in an axial and circumferential manner, the counter-axial force corresponds to one counter-axial force angle, the included angle between the two counter centripetal forces constituting the counter-axial force constitutes the above counter-axial force angle, and the counter-axial force angle depends on the taper of the cone, namely taper angle.

The axial force and the counter-axial force are generated when the inner and outer cones of the cone pair are in effective contact, that is, there is always a pair of corresponding and opposite axial force and counter-axial force in the effective contact process of the inner and outer cones of the cone pair. Both of the axial force and the counter-axial force are bidirectional forces, rather than unidirectional forces, which are distributed in mirror image with the cone axis and/or the thread axis as the center. The cone axis and the thread axis are coincident axes, namely the same axis and/or approximately same axis. The counter-axial force and the axial force are inversely collinear, and the counter-axial force and the axial force are inversely collinear and/or approximately inversely collinear when the above cone and the helical structure are synthesized into the thread and constitute the thread pair. Through cohesion of the inner cone and the external cone till interference, the axial force and the counter-axial force generate the pressure on the contact surface of the inner conical surface and the outer conical surface and are thickly and uniformly distributed on the contact surface of inner and outer conical surfaces in the axial and circumferential manner. When the cohesion movement of the inner cone and the outer cone proceeds all the time till the cone pair reaches interference fit, the generated pressure combines the inner cone with the outer cone, that is, the above pressure can allow the cohesion of the inner cone and the outer cone to form a similar overall structure and the inner and outer cones do not fall off under the action of gravity because the position direction of the above similar overall structure randomly changes after the external force disappears. The cone pair generates self locking, that is, the thread pair generates self locking. Such the self-locking property has a certain limited resisting action on other foreign loads which may lead to mutual separation of the inner and outer cones except gravity. The cone pair also has self-positioning property allowing the mutual fit of the inner cone and the outer cone, but not any axial force angle and/or counter-axial force angle can allow the cone pair to generate self locking and self positioning.

When the axial force angle and/or the counter-axial force angle is less than 180° and greater than 127°, the cone pair has self-locking property; when the axial force angle and/or the counter-axial force angle is infinitely close to 180°, the self-locking property of the cone pair is optimal and the axial bearing capacity of the cone pair is the weakest; when the axial force angle and/or the counter-axial force angle is equal to or less than 127° and greater than 0°, the cone pair is in the weak self-locking area and/or non-self-locking area; when the axial force angle and/or the counter-axial force angle changes in a trend of being infinitely close to 0°, the self-locking property of the cone pair changes in a trend of attenuation till the cone pair completely has no self-locking capacity, and the axial bearing capacity changes in a trend of enhancement till the axial bearing capacity is the strongest.

When the axial force angle and/or the counter-axial force angle is less than 180° and greater than 127°, the cone pair is in a strong self-positioning state and the strong self positioning of the inner and outer cones is easily achieved; when the axial force angle and/or the counter-axial force angle is infinitely close to 180°, the self positioning capability of the inner and outer cones of the cone pair is the strongest; when the axial force angle and/or the counter-axial force angle is equal to or less than 127° and greater than 0°, the cone pair is in a weak self-positioning state; when the axial force angle and/or the counter-axial force angle changes in a trend of being infinity close to 0°, the mutual self-positioning ability of the inner and outer cones of the cone pair changes in a trend of attenuation till they completely have no self-positioning capability.

Compared with an irreversible single-side bidirectional containing-contained relationship borne by only single side of the conical surface of the unidirectional tapered thread of the single tapered body invented previously by the applicant, reversible left-right bidirectional containing of the bidirectional tapered thread of the double tapered body of this bidirectional tapered thread connection pair can be left bearing of the conical surface and/or right bearing of the conical surface and/or left bearing and right bearing of the conical surface and/or simultaneous left and right bearing of the conical surface, even the disordered freedom degree between the tapered hole and the truncated cone body is limited, helical movement allows the bidirectional tapered thread bolt and nut connection structure to obtain the necessary ordered freedom degree, so as to effectively combine the technical features of the cone pair and the thread pair to form a new thread technology.

When the bolt and nut of the bidirectional tapered thread is used, the conical surface of the bidirectional truncated cone body of the bidirectional tapered thread external thread and the bidirectional tapered hole conical surface of the bidirectional thread tapered internal thread are in mutual fit.

In the bolt and nut of the bidirectional tapered thread, the bidirectional tapered body of the cone pair namely the truncated cone body and/or tapered hole can not necessarily achieve the self locking and/or self positioning of the thread connection pair at any taper or any taper angle, and the bidirectional tapered thread bolt and nut connection structure has the self-locking property and self-positioning property as long as the inner and outer cones must reach a certain taper or a certain taper angle. The taper includes the left taper and right taper of the internal and external thread bodies, the taper angle includes the left taper angle and the right taper angle of the internal and external thread bodies, the internal thread and the external thread of the asymmetric bidirectional tapered thread constituting the bolt and nut connection structure of the olive-like shaped asymmetric bidirectional tapered thread have a left taper being larger than a right taper, the left taper corresponds to the left taper angle namely a first taper angle α1, preferably, 0°<first taper angle α1<53°, preferably, the first taper angle α1 is 2°˜40°; for individual special fields, preferably, 53°<first taper angle α1<180°, preferably, the first taper angle α1 is 53°˜90°; the right taper corresponds to the right taper angle namely the second taper angle α2, preferably, 0°<the second taper angle α2<53°, preferably, the second taper angle α2 is 2°˜40°.

The above individual special fields refer to thread connection application fields which have low self-locking property requirement and even need no self-locking property and/or weak self-positioning property and/or high axial bearing force requirement and/or transmission connection must be set.

In the bolt and nut of the bidirectional tapered thread, the external thread is arranged on the outer surface of the columnar body to form the bolt, wherein the columnar body is provided with a screw body, the helically distributed truncated cone body is arranged on the outer surface of the screw body, the truncated cone body includes an asymmetric bidirectional truncated cone body, the columnar body can be solid or hollow and includes a cylindrical and/or non-cylindrical workpieces and objects that need to be machined with the threads on the outer surfaces, including outer surfaces such as a cylindrical surface and a non-cylindrical surface such as a conical surface.

In the bolt and nut of the bidirectional tapered thread, the helical olive-like shaped asymmetrical bidirectional tapered external thread is formed by oppositely jointing two symmetrical lower bottom surfaces of two truncated cone bodies, wherein the two truncated cone bodies have identical lower bottom surfaces and upper top surfaces, but different taper heights; wherein the upper top surfaces of the two truncated cone bodies are located at two ends of the bidirectional truncated cone body, and are respectively jointed with the upper top surfaces of the adjacent bidirectional truncated cone bodies. The external thread includes the truncated cone body first helical conical surface and the truncated cone body second helical conical surface as well as an outer helical line. In the cross section through which the thread axis passes, the complete single-pitch asymmetric bidirectional tapered external thread is an olive-like shaped special bidirectional tapered geometry which is large in the middle and small in two ends and has the taper of the left truncated cone body being larger than that of the right truncated cone body. The asymmetric bidirectional truncated cone body includes a bidirectional truncated cone body conical surface. The included angle formed by two tessellation limes of the left conical surface namely truncated cone body first helical conical surface is the first taper angle α1. The truncated cone body first helical conical surface forms the left taper and is in left-direction distribution, and the included angle between the two tessellation lines of the right conical surface namely truncated cone body second helical conical surface forms the right taper and is in right-direction distribution. The tapers corresponding to the first taper angle α1 and the second taper angle α2 are opposite in direction. The tessellation line refers to an intersecting line of the conical surface and the plane through which the cone axis passes. ( [symbol] ) A shape formed by the truncated cone body first helical conical surface and the truncated cone body second helical conical surface is the same as a shape of a helical outer flank of the rotating body, wherein the rotating body is formed by the right-angled trapezoid union being rotated around the right-angled side of the right-angled trapezoid union, and, at the same time, the right-angled trapezoid union axially moves at a constant speed along the central axis of the columnar body; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the columnar body. The right-angled trapezoid union refers to a special geometry in which the lower bottom sides are the same and upper bottom sides are the same but right-angled sides are different, and the lower bottom sides of two right-angled trapezoids are symmetric and oppositely jointed, and the upper bottom sides are respectively at the two ends of the right-angled trapezoid union.

In the bolt and nut of the bidirectional tapered thread, the internal thread is arranged on the inner surface of the cylindrical body to form a nut, wherein the cylindrical body is provided with the nut body, the inner surface of the nut body is provided with helically distributed tapered holes, the tapered hole includes an asymmetric bidirectional tapered hole, and the cylindrical body includes a cylindrical and/or a non-cylindrical workpieces and objects that need to be machined with internal threads on their inner surfaces. The inner surface includes an inner surface geometrical shape, such as a cylindrical surface and a non-cylindrical surface such as the conical surface.

In the bolt and nut of the bidirectional tapered thread, the asymmetric bidirectional tapered hole namely internal thread is formed by oppositely jointing two symmetrical lower bottom surfaces of two tapered holes, wherein the two tapered holes have identical lower bottom surfaces and upper top surfaces, but different taper heights; wherein the upper top surfaces of the two tapered holes are located at two ends of the bidirectional tapered holes, and are respectively jointed with the upper top surfaces of the adjacent bidirectional tapered holes. The internal thread includes a tapered hole first helical conical surface and a tapered hole second helical conical surface as well as an inner helical line. In the cross section through which the thread axis passes, the complete single-pitch asymmetric bidirectional tapered internal thread is an olive-like shaped special bidirectional tapered geometry which is large in the middle and small at the two ends and has the taper of the left tapered hole being larger than that of the right tapered hole. The bidirectional tapered hole includes a bidirectional tapered hole conical surface. The included angle formed by two tessellation lines of the left conical surface namely tapered hole first helical conical surface is the first taper angle α1. The tapered hole first helical conical surface forms the left taper and is in left-direction distribution, and the included angle between the two tessellation lines of the right conical surface namely tapered hole second helical conical surface is the second taper angle α2. The tapered hole second helical conical surface forms the right taper and is in right-direction distribution. The taper directions corresponding to the first taper angle α1 and the second taper angle α2 are opposite. The tessellation line refers to an intersecting line of the conical surface and the plane through which the cone axis passes. A shape formed by the tapered hole first helical conical surface and the tapered hole second helical conical surface of the bidirectional tapered hole is the same as a shape of a helical outer flank of a rotating body, wherein the rotating body is formed by two bevels of a right-angled trapezoid union being rotated around a right-angled side of the right-angled trapezoid union, and, at the same time, the right-angled trapezoid union axially moves at a constant speed along a central axis of the cylindrical body; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the cylindrical body. The right-angled trapezoid union refers to a special geometry in which the bottom sides are the same and upper bottom sides are the same but right-angled sides are different, and the lower bottom sides of two right-angled trapezoids are symmetric and oppositely jointed, and the upper bottom sides are respectively at the two ends of the right-angled trapezoid union.

When the bolt and nut connection structure of the bidirectional tapered thread works, a relationship between the connection structure and the workpiece includes rigid connection and non-rigid connection. The rigid connection refers to that the nut bearing surface and the workpiece bearing surface are each other's bearing surfaces, including a single nut, double nuts and other structure forms. The non-rigid connection refers to that opposite side end surfaces of two nuts are each other's bearing surfaces and/or if there is a gasket between the same side end surfaces of the two nuts, they are indirect each other's bearing surfaces and mainly applied to non-rigid connection workpieces such as non-rigid materials or transmission parts or application fields meeting requirements through installation of nuts. The workpiece refers to a connected object including the workpiece, and the gasket refers to a spacer including the gasket.

When the bolt and nut of the bidirectional tapered thread adopts a bolt and double nut connection structure and a relationship between the connection structure and the fastened workpiece is rigid connection, the tapered thread bearing surface is different; when the cylindrical body is located at the left side of the fastened workpiece, that is, when the left end surface of the fastened workpiece and the right end surface of the cylindrical body namely the left nut body are locking bearing surfaces of the left nut body and the fastened workpiece, the right helical conical surfaces of the bidirectional tapered threads of the left nut body and the columnar body namely screw body namely bolt, namely the tapered hole second helical conical surface and the truncated cone body second helical conical surface are tapered thread bearing surfaces and the tapered hole second helical conical surface and the truncated cone body second helical conical surface are each other's bearing surfaces. When the cylindrical nut body is located at the right side of the fastened workpiece, that is, the right end surface of the fastened workpiece and the left end surface of the cylindrical body namely right nut body are locking bearing surfaces of the right nut body and the fastened workpiece, the left helical conical surfaces of the bidirectional tapered threads of the right nut body and the columnar body namely screw body, namely the first helical conical surfaces of the bidirectional tapered thread of the bolt, that is, the tapered hole first helical conical surface and the truncated cone body first helical conical surface are tapered thread bearing surfaces and the tapered hole first helical conical surface and the truncated cone body first helical conical surface are each other's bearing surfaces.

When the bolt and nut of the bidirectional tapered thread adopts a bolt and single nut connection structure and a relationship between the connection structure and the fastened workpiece is rigid connection, and when the hexagonal head of the bolt is located at the left side, the cylindrical body namely nut body namely single nut is located at the right side of the fastened workpiece and the bolt and single nut connection structure works, the right end surface of the workpiece and the left end surface of the nut body are locking bearing surfaces of the nut body and the fastened workpiece, the nut body and the columnar body namely screw body namely the left helical conical surfaces of the bidirectional tapered thread of the bolt namely the tapered hole first helical conical surface and the truncated cone body first helical conical surface are tapered thread bearing surfaces and the tapered hole first helical conical surface and the truncated cone body first helical conical surface are each other's bearing surfaces; when the hexagonal head of the bolt is located at the right side, the cylindrical body namely nut body namely the single nut is located at the left side of the fastened workpiece. When the bolt and single nut connection structure works, the left end surface of the workpiece and the right end surface of the nut body are locking bearing surfaces of the nut body and the fastened workpiece, the nut body and the columnar body namely screw body namely the right helical conical surfaces of the bidirectional tapered thread of the bolt namely the tapered hole second helical conical surface and the truncated cone body second helical conical surface are tapered thread bearing surfaces and the tapered hole second helical conical surface and the truncated cone body second helical conical surface are each other's bearing surfaces.

When the bolt and nut of the bidirectional tapered thread adopts the bolt and double nut connection structure and a relationship between the connection structure and the fastened workpiece are non-rigid connection, the thread work bearing surface namely the tapered thread bearing surface is different, the cylindrical body includes a left nut body and a right nut body, and the right end surface of the left nut body and the left end surface of the right nut body are oppositely and directly contacted and are each other's locking bearing surfaces. When the right conical surfaces of the directional tapered threads of the left nut body and the columnar body namely screw body namely bolt, namely the tapered hole second helical conical surface and the truncated cone body second helical conical surface are tapered thread bearing surfaces and the tapered hole second helical conical surface and the truncated cone body second helical conical surface are each other's bearing surfaces. When the left end surface of the right nut body is the locking bearing surface, the left conical surfaces of the directional tapered threads of the right nut body and the columnar body namely screw body namely bolt, namely the tapered hole first helical conical surface and the truncated cone body first helical conical surface are tapered thread bearing surfaces and the tapered hole first helical conical surface and the truncated cone body first helical conical surface are each other's bearing surfaces.

When the bolt and nut of the bidirectional tapered thread adopts the bolt and double nut connection structure and a relationship between the connection structure and the fastened workpiece are non-rigid connection, the thread work bearing surface namely tapered thread bearing surface is different, the cylindrical body includes a left nut body and a right nut body, and there is a spacer such as gasket between two cylindrical base bodies namely the left nut body and the right nut body. The right end surface of the left nut body and the left end surface of the right nut body are in opposite and indirect contact via the gasket and therefore are indirect each other's locking bearing surfaces. When the cylindrical body is located at the left side of the gasket namely the left side surface of the gasket, and the right end surface of the left nut body is the locking bearing surface of the left nut body, the right helical conical surfaces of the bidirectional tapered threads of the left nut body and the columnar body namely screw body namely bolt, namely the tapered hole second helical conical surface and the truncated cone body second helical conical surface are tapered thread bearing surfaces and the tapered hole second helical conical surface and the truncated cone body second helical conical surface are each other's bearing surfaces. When the cylindrical body is located at the right side of the gasket namely the right side surface of the gasket and the left end surface of the right nut body is the locking bearing surface of the right nut body, the left helical conical surfaces of the bidirectional tapered threads of the right nut body and the columnar body namely screw body namely bolt, namely the tapered hole first helical conical surface and the truncated cone body first helical conical surface are tapered thread bearing surfaces and the tapered hole first helical conical surface and the truncated cone body first helical conical surface are each other's bearing surfaces.

When the bolt and nut of the bidirectional tapered thread adopts the bolt and double nut connection structure and a relationship between the connections structure and the fastened workpiece is non-rigid connection, when the cylindrical body inside namely nut body adjacent to the fastened workpiece has been effectively combined with the columnar body namely screw body namely bolt, that is, the internal thread and the external thread which constitute the thread connection pair are effectively cohered together, the cylindrical body outside namely the nut body adjacent to the fastened workpiece can remain unchanged and/or is disassembled according to application working conditions and only one nut is left (for example application fields which have requirements on light weigh of equipment or double buts are not needed to ensure the reliability of the connection technology), the disassembled nut body is used only as an installation process nut rather than a connection nut. Besides being manufactured using the bidirectional tapered thread, the internal thread of the installation process nut is a nut body manufactured using an unidirectional tapered thread and using other threads screwed with the tapered threads, including a triangular thread, a trapezoidal thread, a sawtooth thread and other nut bodies manufactured by traditional threads. On the premise of ensuring the reliability of the connection technology, the tapered thread connection pair is a closed-loop fastening technology system, that is, after the internal thread and external thread of the tapered thread connection pair can be effectively cohered, the tapered thread connection pair will automatically become an independent technical system without relying on the technical compensation of the third party to ensure the technical effectiveness of the connection technology system, that is, even if there are no supports of other objects, including a gap exists between the tapered thread connection pair and the fastened workpiece, the effectiveness of the tapered thread connection pair is not affected, which will facilitates significant reduction of the weight of the equipment, removal of the invalid load and promotion of the effective load capability of the equipment, braking performance, energy conservation and emission reduction and other technical requirements, and is a thread technology advantage that is unique when the relationship between the bidirectional tapered thread bolt and nut connection structure and the fastened workpiece is non-rigid connection or rigid connection, exclusive of other thread technologies.

When being in transmission connection, the bolt and nut of the bidirectional tapered thread is in bidirectional bearing through screw connection of the bidirectional tapered hole and the bidirectional truncated cone body. When the external thread and the internal thread constitute the thread pair, there must be a clearance between the bidirectional truncated cone body and the bidirectional tapered hole. If there is an oily medium between the internal thread and the external thread for lubrication, a bearing oily film will be easily formed, and the clearance is beneficial to formation of the bearing oily film. The bolt and nut of the bidirectional tapered thread is applied to transmission connection, which is equivalent to a group of sliding bearing pairs composed of one pair and/or several pairs of sliding bearings, that is, each bidirectional tapered internal thread bi-directionally contains a corresponding traditional external thread so as to form a pair of sliding bearings. The pitch number of the formed sliding bearings is adjusted according to application working conditions, that is, the bidirectional tapered internal thread and the traditional external thread are effectively and bi-directionally jointed, that is, the pitch number of the containing-contained threads that are effectively and bi-directionally in contact cohesion is designed according to application working conditions, and the bidirectional truncated cone body is received through the bidirectional tapered hole and is positioned in multiple directions such as radial direction, axial direction, angular direction and circumferential direction. Preferably, the bidirectional truncated cone body is received through the bidirectional tapered hole and mainly positioned in radial and circumferential directions with the help of assistant positioning in axial and angular directions, and then the multi-directional positioning of inner and outer cones is formed till the conical surface of the bidirectional tapered hole and the conical surface of the bidirectional truncated cone body are cohered to realize the self positioning or till self locking is generated by means of fixed-diameter interference contact, so as to form a special cone pair and thread pair synthesis technology to ensure the accuracy, efficiency and reliability of the transmission connection of the tapered thread technology, especially the bidirectional tapered thread bolt and nut connection structure.

When the bolt and nut of the bidirectional tapered thread is in fastening connection and in sealing connection, its technical performance is realized by screw connection of the bidirectional tapered hole and the directional truncated cone body, that is, the truncated cone body first helical conical surface and the tapered hole first helical conical surface are in fixed-diameter interference and/or the truncated cone body second helical conical surface and the tapered hole second helical conical surface are in fixed-diameter interference. According to application working conditions, bearing in one direction and/or simultaneous and respectively bearing in two directions are achieved, that is, the inner cone and the outer cone of the bidirectional truncated cone body and the bidirectional tapered hole are in inner diameter/outer diameter centring under the guidance of the helical line till the tapered hole first helical conical surface and the truncated cone body first helical conical surface are cohered to reach bearing in one direction or simultaneous and respective bearing in two directions till fixed-diameter fit or till fixed-diameter interference contact and/or the tapered hole second helical conical surface and the truncated cone body second helical conical surface are cohered to reach bearing in one direction or simultaneous and respective bearing in two direction till fixed-diameter fit or till fixed-diameter interference contact, that is, the multi-directional positioning of the inner and outer cones is formed through the self locking as well as radial, axial, angular and circumferential positioning of the bidirectional inner and outer cones of the tapered external thread received by the bidirectional inner cone of the tapered internal thread, preferably, through the directional truncated cone body received in the bidirectional tapered hole and main positioning in radial and circumferential directions with the help of assistant positioning in axial and angular directions, the multi-directional positioning of the inner and outer cones is formed till the bidirectional tapered hole conical surface and the bidirectional truncated cone body are cohered to realize self positioning till fixed-diameter interference to generate self locking, so as to form a special cone pair and thread pair synthesis technology to ensure the effectiveness and reliability of the tapered thread technology, especially the bolt and nut of the bidirectional tapered thread, thereby realizing technical performances of mechanical mechanisms, such as connection, locking, loosening prevention, bearing, fatigue and sealing.

Therefore, transmission accuracy, effectiveness, bearing capability, self-locking force, loose prevention capability, sealing property and other technical properties of the bolt and nut of the bidirectional tapered thread are related to the truncated cone body first helical conical surface and the formed left taper namely corresponding first taper angle α1, the truncated cone body second helical conical surface and the formed right taper namely corresponding second taper angle α2, and the tapered hole first helical conical surface and the formed left taper namely first taper angle α1 and the tapered hole second helical conical surface and the formed right taper namely second tapered angle α2. The material friction coefficients, machining qualities and application working conditions of the columnar body and the cylindrical body can also affect cone fit to a certain extent.

In the bolt and nut of the above bidirectional tapered thread, when the right-angled trapezoid union rotates a circle at a constant speed, the axial movement distance of the right-angled trapezoid union is at least double a length of the sum of the right-angled sides of the two right-angled trapezoids with the same lower bottom sides and the same upper bottom sides but different right-angled sides. This structure ensures that the truncated cone body first helical conical surface and the truncated cone body second helical conical surface as well as the tapered hole first helical conical surface and the tapered hole second conical surface have enough lengths, thus ensuring that the bidirectional truncated cone body conical surface has sufficiently effective contact area and strength as well as efficiency required by helical movement when being matched with the bidirectional tapered hole conical surface.

In the bolt and nut of the above bidirectional tapered thread, when the right-angled trapezoid union rotates a circle at a constant speed, the axial movement distance of the right-angled trapezoid union is equal to a length of the sum of the right-angled sides of the two right-angled trapezoids with the same lower bottom sides and the same upper bottom sides but different right-angled sides. This structure ensures that the truncated cone body first helical conical surface and the truncated cone body second helical conical surface as well as the tapered hole first helical conical surface and the tapered hole second helical conical surface have enough lengths, thus ensuring that the bidirectional truncated cone body conical surface has a sufficiently effective contact area and strength as well as efficiency required by helical movement when being matched with the bidirectional tapered hole conical surface.

In the bolt and nut of the above bidirectional tapered thread, both of the truncated cone body first helical conical surface and the truncated cone body second helical conical surface are continuous helical surfaces or discontinuous helical surfaces; both of the tapered hole first helical conical surface and the tapered hole second helical conical surface are continuous helical surfaces or discontinuous helical surfaces.

In the bolt and nut of the above bidirectional tapered thread, when the connection hole of the cylindrical body is screwed into the screw-in end of the columnar body, the screw-in direction is required, that is, the connection hole of the cylindrical body cannot be screwed in along the opposite direction.

In the bolt and nut of the above bidirectional tapered thread, one end of the columnar body is provided with a head whose size is larger than the outer diameter of the columnar body and/or one end and/or two ends of the columnar body are provided with heads whose sizes are less than the small diameters of the bidirectional tapered external thread of the screw body of the columnar body, and the connection hole is the thread hole formed on the nut. That is, the columnar patent body herein and the head are connected to form a bolt, the bolt which has no head and/or heads at the two ends being smaller than the small diameter of the bidirectional tapered external thread and/or has no thread in the middle and bidirectional tapered external threads respectively at two ends is a double-screw bolt, and the connection hole is formed in the nut.

Compared with the prior art, the bolt and nut connection structure of the bidirectional tapered thread has the advantages of reasonable design, simple structure, convenient operation, large locking force, large bearing force, good anti-loosing property, high transmission efficiency and accuracy, good mechanical seal effect and good stability, is capable of preventing loosing when connection and has self-locking and self-positioning functions, and fastening and connection functions are achieved through bidirectional bearing or sizing of the cone pair formed by coaxial centring of inner and outer diameters of the inner and outer cones till interference fit.

### DESCRIPTION OF THE DRAWINGS

FIG. 1 is a diagram of a bolt and nut connection structure of an olive-like (left taper is greater than right taper) shaped asymmetric bidirectional tapered thread in embodiment 1 provided by the disclosure.

FIG. 2 is a structural diagram of a bolt of an olive-like shaped asymmetric bidirectional tapered thread internal thread and a complete unit thread of an external thread in embodiment 1 provided by the disclosure.

FIG. 3 is a structure diagram of a nut body of an olive-like shaped asymmetric bidirectional tapered thread internal thread and a complete unit thread of an internal thread in embodiment 1 provided by the disclosure.

FIG. 4 is a diagram of a bolt and single nut connection structure of an olive-like (left taper is greater than right taper) shaped asymmetric bidirectional tapered thread in embodiment 2 provided by the disclosure.

FIG. 5 is a diagram of a bolt and double nut connection structure of an olive-like (left taper is greater than right taper) shaped asymmetric bidirectional tapered thread in embodiment 3 provided by the disclosure.

FIG. 6 is a diagram of a bolt and double nut (with a gasket in the middle) connection structure of an olive-like (left taper is greater than right taper) shaped asymmetric bidirectional tapered thread in embodiment 4 provided by the disclosure.

FIG. 7 is a diagram of “the thread in the existing thread technology is a bevel on a cylindrical or conical surface” in the background technology of the disclosure.

FIG. 8 is a diagram of “bevel slider model based on the existing thread technology principle-bevel principle” in the background technology of the disclosure.

FIG. 9 is a diagram of “lead angle in the existing thread technology” in the background technology of the disclosure.

In the figures, tapered thread 1, cylindrical body 2, nut body 21, nut body 22, columnar body 3, screw body 31, tapered hole 4, bidirectional tapered hole 41, bidirectional tapered hole conical surface 42, tapered hole first helical conical surface 421, first taper angle α1, tapered hole second helical conical surface 422, second taper angle α2, inner helical line 5, internal thread 6, truncated cone body 7, bidirectional truncated cone body 71, bidirectional truncated cone body conical surface 72, truncated cone body helical conical surface 721, first taper angle α1, truncated cone body second helical conical surface 722, second taper angle α2, outer helical line 8, external thread 9, olive-like 93, left taper 95, right taper 96, left-direction distribution 97, right-direction distribution 98, thread connection pair and/or thread pair 10, clearance 101, locking bearing surface 111, locking bearing surface 112, tapered thread bearing surface 122, tapered thread bearing surface 121, workpiece 130, nut body locking direction 131, gasket 132, cone axis 01, thread axis 02, slider A on a bevel body, bevel B, gravity G, component G1 of gravity along the bevel, friction force F, lead angle φ, equivalent friction angle P, large traditional external thread diameter d, small traditional external thread diameter d1, and middle traditional external thread diameter d2.

### DETAILED DESCRIPTION OF PREFERRED EMBODIMENTS

Next, the disclosure will be further described in detail in combination with drawings and embodiments.

### Embodiment 1

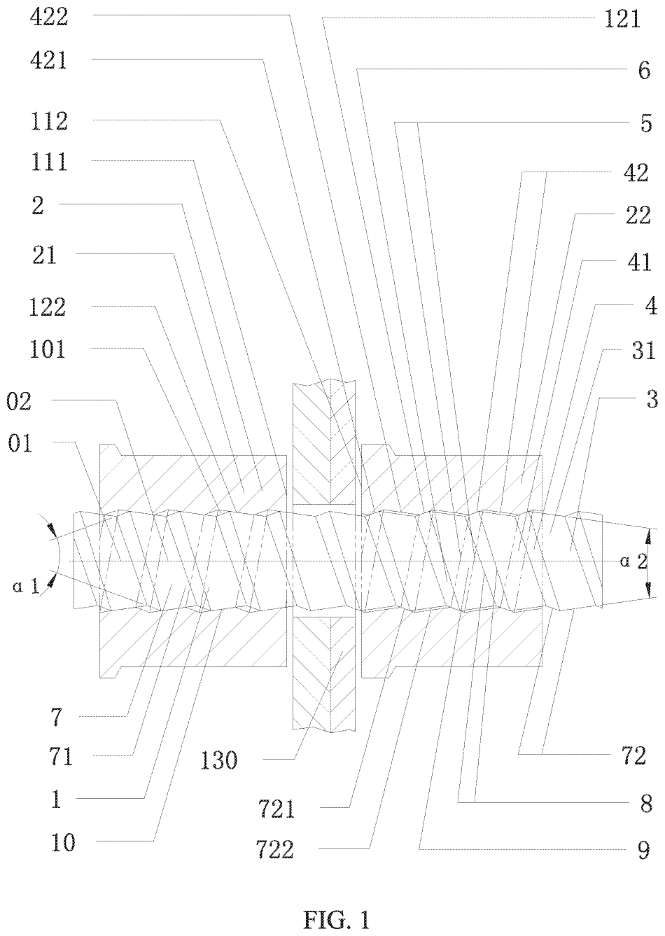

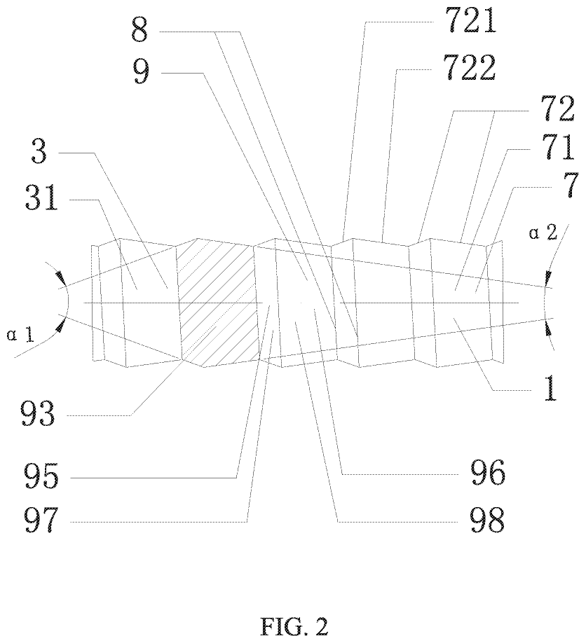

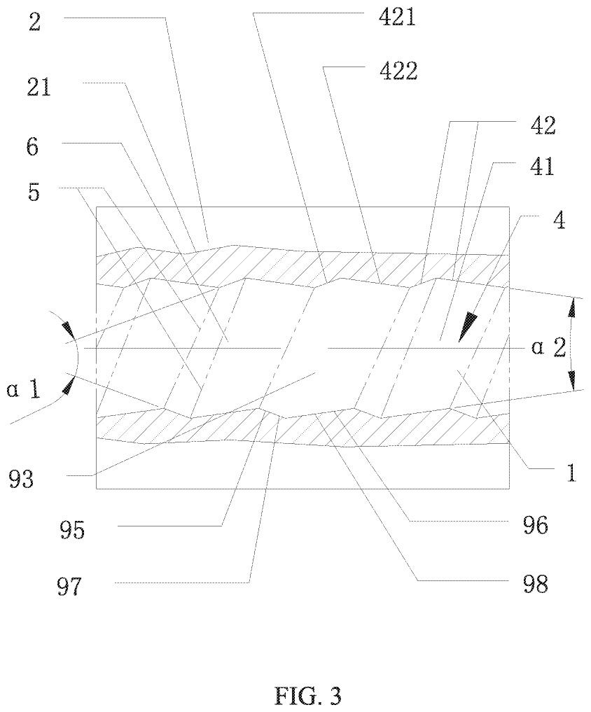

As shown in FIG. 1, FIG. 2 and FIG. 3, this embodiment adopts a bolt and double nut connection structure, including a bidirectional truncated cone body 71 helically distributed on the outer surface of the columnar body 3 and a bidirectional tapered hole helically distributed on the inner surface of the cylindrical body 2, that is, including an external thread 9 and an internal thread 6 which are in mutual thread fit, the internal thread 6 is presented by the helical bidirectional tapered hole 41 and exists in a form of “non-entity space”, and the external thread 9 is presented by the helical bidirectional truncated cone body 71 and exists in a form of “material entity”. The relationship between the internal thread 6 and the external thread 9 is a containing-contained relationship: the internal thread 6 and the external thread 9 are formed by screwing and sleeving bidirectional tapered geometries one by one to be cohered till interference fit, that is, the bidirectional tapered hole 41 contains the bidirectional truncated cone body 71 pitch by pitch, the disorder freedom degree between the tapered hole 4 and the truncated cone body 7 is bi-directionally contained and limited, helical movement also allows the tapered thread connection pair 10 of the bolt and the nut of the bidirectional tapered thread to acquire necessary order freedom degree, so as to effectively synthesize the technical features of the cone pair and the thread pair.

In the bolt and nut of the bidirectional tapered thread in this embodiment, when the truncated cone body 7 and/or tapered hole 4 of the tapered thread connection pair 10 reaches a certain taper, that is, the cone constituting the cone pair reaches a certain taper angle, the tapered thread connection pair 10 has self-locking property and self-positioning property. The taper includes left taper 95 and right taper 96, the taper angle includes a left taper angle and a right taper angle. In this embodiment, the asymmetric bidirectional tapered thread 1 has the left taper 95 being larger than the right taper 96. The left taper 95 corresponds to the left taper angle namely first taper angle α1, preferably, 0°<first taper angle α1<53°, preferably, the first taper angle α1 is 2°˜40°; for individual special fields, namely connection application fields that do not need self-locking property and/or weak self-locking property and/or high axial bearing capability requirement, preferably, 53°≤first taper angle α1<180°, preferably, the first taper angle α1 is 53°˜90°; the right taper 96 corresponds to the right taper angle namely second taper angle α2, preferably, 0°<second taper angle α2<53°, preferably, the second taper angle α2 is 2°˜40°.

The external thread 9 is arranged on the outer surface of the columnar body 3, wherein the columnar body 3 is provided with a screw body 31, the outer surface of the screw body 31 is provided with the helically distributed truncated cone body 7, the truncated cone body 7 includes the asymmetric bidirectional truncated cone body 71, the asymmetric bidirectional truncated cone body 71 is an olive-like 93 shaped special bidirectional tapered geometry. The columnar body 3 can be solid or hollow, including a cylinder, a cone, a tube and other workpieces and objects that need to be machined with external threads on their outer surfaces.

The olive-like 93 shaped asymmetric bidirectional truncated cone body 71 is characterized by being formed by oppositely jointing two symmetrical lower bottom surfaces of two truncated cone bodies, wherein the two truncated cone bodies have identical lower bottom surfaces and upper top surfaces, but different taper heights; wherein the upper top surfaces of the two truncated cone bodies are located at two ends of the bidirectional truncated cone body 71, and are respectively jointed with the upper top surfaces of the adjacent bidirectional truncated cone bodies 71, and the outer surface of the truncated cone body 7 is provided with the asymmetric bidirectional truncated cone body conical surface 72. The external thread 9 includes the truncated cone body first helical conical surface 721 and the truncated cone body second helical conical surface 722 as well as an outer helical line 8. In the cross section through which the thread axis 02 passes, the complete single-pitch asymmetric bidirectional tapered external thread 9 is an olive-like 93 shaped special bidirectional conical geometry which is large in the middle and small in two ends. The asymmetric bidirectional truncated cone body 71 includes a bidirectional truncated cone body conical surface 72. The included angle formed by two tessellation limes of the left conical surface namely truncated cone body first helical conical surface 721 is the first taper angle α1. The truncated cone body first helical conical surface 721 forms the left taper 95 and is in left-direction distribution 97, and the included angle between the two tessellation lines of the right conical surface namely truncated cone body second helical conical surface 722 is the second taper angle α2. The truncated cone body second helical conical surface 722 forms the right taper 96 and is in right-direction distribution 98. The tapers corresponding to the first taper angle α1 and the second taper angle α2 are opposite in direction. The tessellation line refers to an intersecting line of the conical surface and the plane through which the cone axis 01 passes. A shape formed by the truncated cone body first helical conical surface 721 and the truncated cone body second helical conical surface 722 of the bidirectional truncated cone body 71 is the same as a shape of a helical outer flank of the rotating body, wherein the rotating body is formed by the right-angled trapezoid union being rotated around the right-angled side of the right-angled trapezoid union, and, at the same time, the right-angled trapezoid union axially moves at a constant speed along the central axis of the columnar body 3; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the columnar body 3. The right-angled trapezoid union refers to a special geometry in which the lower bottom sides are the same and upper bottom sides are the same but right-angled sides are different, and the lower bottom sides of two right-angled trapezoids are symmetric and oppositely jointed, and the upper bottom sides are respectively at the two ends of the right-angled trapezoid union.

The internal thread 6 is arranged on the inner surface of the cylindrical body 2, wherein the cylindrical body 2 includes a nut body 21 and a nut body 22, the inner surfaces of the nut body 21 and the nut body 22 are provided with helically distributed tapered holes 4, the tapered hole 4 includes the asymmetric bidirectional tapered hole 41, the asymmetric bidirectional tapered hole 41 is an olive-like 93 shaped special bidirectional tapered geometry, and the cylindrical body 2 includes cylindrical and/or non-cylindrical workpieces and objects that need to be machined with internal threads on their inner surfaces.

The olive-like 93 shaped asymmetric bidirectional tapered hole 41 is characterized by being formed by oppositely jointing two symmetrical lower bottom surfaces of two tapered holes, wherein the two tapered holes have identical lower bottom surfaces and upper top surfaces, but different taper heights; wherein the upper top surfaces of the two tapered holes are located at two ends of the bidirectional tapered holes 41, and are respectively jointed with the upper top surface of the adjacent bidirectional tapered holes 41. The tapered hole 4 includes an asymmetric bidirectional tapered conical surface 42. The internal thread 6 includes the tapered hole first helical conical surface 421 and the tapered hole second helical conical surface 422 as well as an inner helical line 5. In the cross section through which the thread axis 02 passes, the complete single-pitch asymmetric bidirectional tapered internal thread 6 is an olive-like 93 shaped special bi-directional conical geometry which is large in the middle and small in two ends. The bidirectional tapered hole 41 includes a bidirectional tapered hole conical surface 42. The included angle formed by two tessellation limes of the left conical surface namely tapered hole first helical conical surface 421 is the first taper angle α1. The tapered hole first helical conical surface 421 forms the left taper 95 and is in left-direction distribution 97, and the included angle between the two tessellation lines of the right conical surface namely tapered hole second helical conical surface 422 is the second taper angle α2. The tapered hole second helical conical surface 422 forms the right taper 96 and is in right-direction distribution 98. The tapers corresponding to the first taper angle α1 and the second taper angle α2 are opposite in direction. The tessellation line refers to an intersecting line of the conical surface and the plane which through the cone axis 01 passes. A shape formed by the tapered hole first helical conical surface 421 and the tapered hole second helical conical surface 422 is the same as a shape of a helical outer flank of a rotating body, wherein the rotating body is formed by two bevels of a right-angled trapezoid union being rotated around a right-angled side of the right-angled trapezoid union, and, at the same time, the right-angled trapezoid union axially moves at a constant speed along a central axis of the cylindrical body 2; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the cylindrical body 2. The right-angled trapezoid union refers to a special geometry in which the bottom sides are the same and upper bottom sides are the same but right-angled sides are different, and the lower bottom sides of two right-angled trapezoids are symmetric and oppositely jointed, and the upper bottom sides are respectively at the two ends of the right-angled trapezoid union.

In this embodiment, the bolt and nut connection structure is adopted, the double nuts include the nut body 21 located at the left side of the fastened workpiece 130 and the nut body 22 located at the right side of the fastened workpiece 130. When the bolt and the double nuts work, a relationship between the double nuts and the fastened workpiece 130 is a rigid connection. The rigid connection refers to a fact that the bearing surface of the nut end surface and the bearing surface of the workpiece are each other's bearing surfaces, including a locking bearing surface 111 and a locking bearing surface 112. The workpiece 130 refers to a connected object including the workpiece 130.

The thread work bearing surface in this embodiment is different, including a tapered thread bearing surface 121 and a tapered thread bearing surface 122. When the cylindrical body 2 is located at the left side of the fastened workpiece 130, that is, the left end surface of the fastened workpiece 130 and the right end surface of the cylindrical body 2 namely left nut body 21 are locking bearing surfaces 111 of the left nut body 21 and the fastened workpiece 130, the right helical conical surface of the bidirectional tapered thread 1 of the left nut body 21 and the columnar body 3 namely screw body 31 namely bolt is the thread work bearing surface, that is, the tapered hole second helical conical surface 422 and the truncated cone body second helical conical surface 722 are tapered hole thread bearing surfaces 122, and the tapered hole second helical conical surface 422 and the truncated cone body second helical conical surface 722 are each other's bearing surfaces. When the cylindrical body 2 is located at the right side of the fastened workpiece 130, that is, the right end surface of the fastened workpiece 130 and the left end surface of the cylindrical body 2 namely right nut body 22 are locking bearing surfaces 112 of the right nut body 22 and the fastened workpiece 130, the left helical conical surface of the bidirectional tapered thread 1 of the right nut body 22 and the columnar body 3 namely screw body 31 namely bolt is the thread work bearing surface, that is, the tapered hole first helical conical surface 421 and the truncated cone body first helical conical surface 721 are tapered thread bearing surfaces 121, and the tapered hole first helical conical surface 421 and the truncated cone body first helical conical surface 721 are each other's bearing surfaces.

When being in transmission connection, the bidirectional tapered internal thread and the traditional thread are in bidirectional bearing through screw connection of the bidirectional tapered hole 41 and the special tapered body 7 of the traditional external thread 9. When the external thread Sand the internal thread 6 constitute the thread pair 10, there must be a clearance 101 between the bidirectional tapered hole 41 and the special tapered body 7 of the traditional external thread 9. If there is an oily medium between the internal thread 6 and the external thread 9 for lubrication, a bearing oily film will be easily formed, the clearance 101 is beneficial to formation of the bearing oily film. The thread connection pair 10 is equivalent to a group of sliding bearing pairs composed of one pair and/or several pairs of sliding bearings, that is, each bidirectional tapered internal thread 6 bi-directionally receives a corresponding bidirectional external thread 9 so as to form a pair of sliding bearings. The number of the formed sliding bearings is adjusted according to application working conditions, that is, the bidirectional tapered internal thread 6 and the bidirectional external thread 9 are effectively and directionally jointed, that is, the number of containing-contained threads that are effectively and directionally in contact cohesion is designed according to application working conditions, and the truncated cone body 7 is bi-directionally received through the tapered hole 4 and is positioned in multiple directions such as radial, axial, angular and circumferential directions, so as to form a special cone pair and thread pair synthesis technology to ensure the tapered thread technology, especially the accuracy, efficiency and reliability of the transmission connection of the bolt and nut connection structure of the bidirectional tapered thread.

When the bolt and nut of the bidirectional tapered thread is in fastening connection and in sealing connection, its technical performance is realized by screw connection of the bidirectional tapered hole 41 and the bidirectional truncated cone body 71, that is, realized by fixed-diameter interference between the truncated cone body first helical conical surface 721 and the tapered hole first helical conical surface 421 and/or fixed-diameter interference between the truncated cone body second helical conical surface 722 and the tapered hole second helical conical surface 422. According to application working conditions, bearing in one direction and/or simultaneous and respective bearing in two directions are achieved, that is, the bidirectional truncated cone body 71 and the bidirectional tapered hole 41 are subjected to centring of the inner and outer diameters of the inner cone and the outer cone under the guidance of the helical line till the tapered hole first helical conical surface 421 and the truncated cone body first helical conical surface 721 are cohered till interference contact and/or the tapered hole second helical conical surface 422 and the truncated cone body second helical conical surface 722 are cohered till interference contact, thereby realizing technical performances of mechanical mechanisms, such as connection, locking, loosening prevention, bearing, fatigue and sealing.

Therefore, transmission accuracy, transmission effectiveness, bearing capability, self-locking force, loose prevention capability, sealing property and other technical properties of the bolt and nut of the bidirectional tapered thread in this embodiment are related to the truncated cone body first helical conical surface 721 and its formed left taper 95 namely first taper angle α1 and the truncated cone body second helical conical surface 722 and its formed right taper 96 namely second taper angle α2 as well as the tapered hole first helical conical surface 421 and its left taper 95 namely first taper angle α1 and the tapered hole second helical conical surface 422 and its right taper 96 namely second taper angle α2. The material friction coefficients, machining qualities and application workings condition of the columnar body 3 and the cylindrical body 2 can also affect cone fit to a certain extent.

In the bolt and nut of the above bidirectional tapered thread, when the right-angled trapezoid union rotates a circle at a constant speed, the axial movement distance of the right-angled trapezoid union is at least double a length of the sum of the right-angled sides of two right-angled trapezoids with the same lower bottom sides and the same upper bottom sides but different right-angled sides. This structure ensures that the truncated cone body first helical conical surface 721 and the truncated cone body second helical conical surface 722 as well as the tapered hole first helical conical surface 421 and the tapered hole second helical conical surface 422 have enough lengths, thus ensuring that the bidirectional truncated cone body conical surface 72 and the bidirectional tapered hole conical surface 42 have sufficiently effective contact areas and strengths and efficiency required by helical movement when being fit.

In the bolt and nut of the above bidirectional tapered thread, when the right-angled trapezoid union rotates a circle at a constant speed, the axial movement distance of the right-angled trapezoid union is equal to a length of the sum of the right-angled sides of the two right-angled trapezoids with the same lower bottom sides and the same upper bottom sides but different right-angled sides. This structure ensures that the truncated cone body first helical conical surface 721 and the truncated cone body second helical conical surface 722 as well as the tapered hole first helical conical surface 421 and the tapered hole second helical conical surface 422 have enough lengths, thus ensuring that the bidirectional truncated cone body conical surface 72 and the bidirectional tapered hole conical surface 42 have sufficiently effective contact areas and strengths and efficiency required by helical movement when being fit.

In the bolt and nut of the above bidirectional tapered thread, both of the truncated cone body first helical conical surface 721 and the truncated cone body second helical conical surface 722 are continuous helical surfaces or discontinuous helical surfaces; both of the tapered hole first helical conical surface 421 and the tapered hole second helical conical surface 422 are continuous helical surfaces or discontinuous helical surfaces.

In the bolt and nut of the above directional tapered thread, the connection hole of the cylindrical body 2 is screwed into the screw-in end of the columnar body 3, the screw-in direction is required, that is, the connection hole of the cylindrical body 2 cannot be screwed along the opposition direction.

In the bolt and nut of the above bidirectional tapered thread, one end of the columnar body 3 is provided with a head having a size larger than the outer diameter of the columnar body 3 and/or the one end or two ends of the columnar body 3 are provided with a head having a size smaller than the small diameter of the tapered thread external thread 9 of the screw body 31 of the columnar body 3, the connection hole is the thread hole formed on the nut body 21. That is, the columnar body 3 herein and the head are connected to form the bolt, and the bolt which has no head and/or heads at the two ends being smaller than the small diameter of the bidirectional tapered external thread 9 and/or has no thread in the middle and bidirectional tapered external threads 9 respectively at two ends is a double-screw bolt, and the connection hole is formed in the nut body 21.

Compared with the prior art, the tapered thread connection pair 10 of the bolt and nut connection structure of the bidirectional tapered thread has the advantages of reasonable design, simple structure, convenient operation, large locking force, large bearing force, good anti-loosing property, high transmission efficiency and accuracy, good mechanical seal effect and good stability, is capable of preventing release when connection and has self-locking and self-positioning functions, and fastening and connection functions are achieved through sizing of the cone pair formed by inner and outer cones till interference fit.

### Embodiment 2

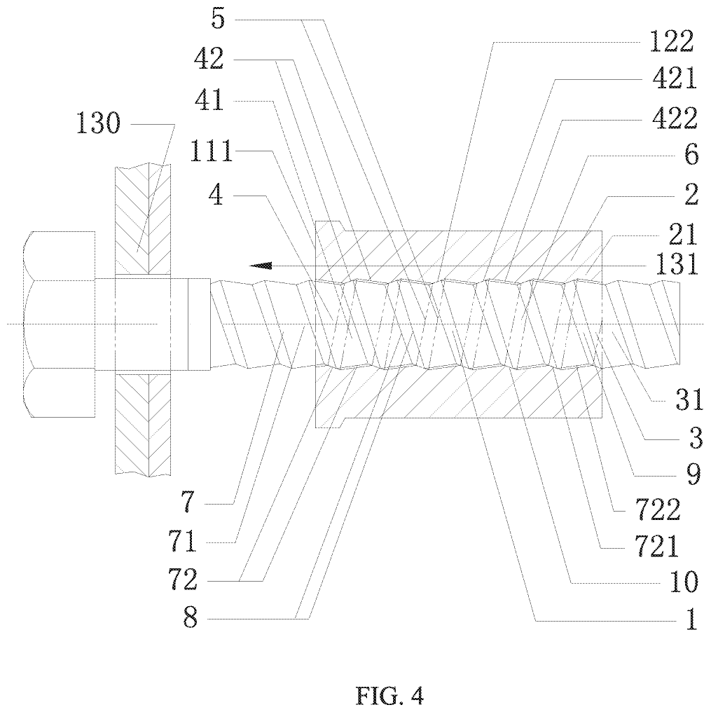

As shown in FIG. 4, the structure, principle and implementation steps of this embodiment are the same as those in embodiment 1. The difference is that this embodiment adopts the bolt and single nut connection structure, and the bolt body has a hexagonal head larger than the screw body 31. When the hexagonal head is located at the left side, the cylindrical body 2 namely nut body 21 namely single nut is located at the right side of the fastened workpiece 130. When the bolt and single nut connection structure in this embodiment works, a relationship between the connection structure and the fastened workpiece 130 is similarly rigid connection. The rigid connection refers to a fact that the end surface of the nut body 21 and the opposite end surface of the end surface of the workpiece 130 are each other's bearing surfaces. The bearing surface is a locking bearing surface 111. The workpiece 130 refers to a connected object including the workpiece 130.

The thread work bearing surface in this embodiment is the tapered thread bearing surface 122, that is, the cylindrical body 2 namely nut body 21 namely single nut is located at the right side of the fastened workpiece 130. When the bolt and single nut connection structure works, the right end surface of the workpiece 130 and the left end surface of the nut body 21 are locking bearing surfaces 111 of the nut body 21 and the fastened workpiece 130. The left helical conical surfaces of the bidirectional tapered threads 1 of the nut body 21 and the columnar body 3 namely screw body 31 namely bolt are the thread work bearing surfaces, that is, the tapered hole first helical conical surface 421 and the truncated cone body first helical conical surface 721 are the tapered thread bearing surfaces 122 and the tapered hole first helical conical surface 421 and the truncated cone body first helical conical surface 721 are each other's bearing surfaces.

In this embodiment, when the hexagonal head is located at the right side, the structure, principle and implementation steps are the same as those in this embodiment.

### Embodiment 3

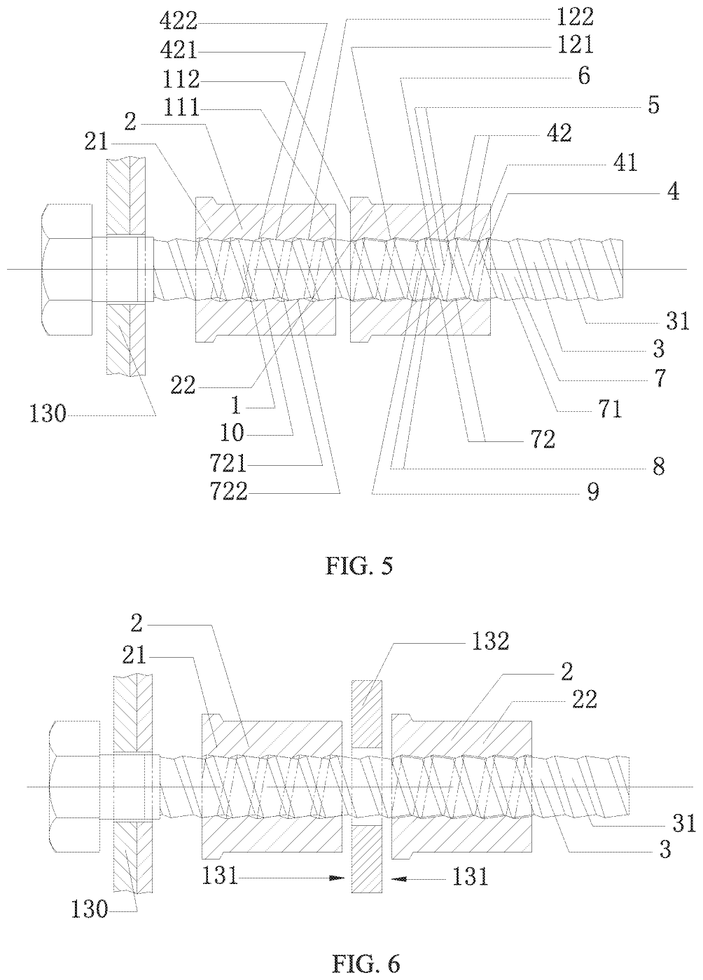

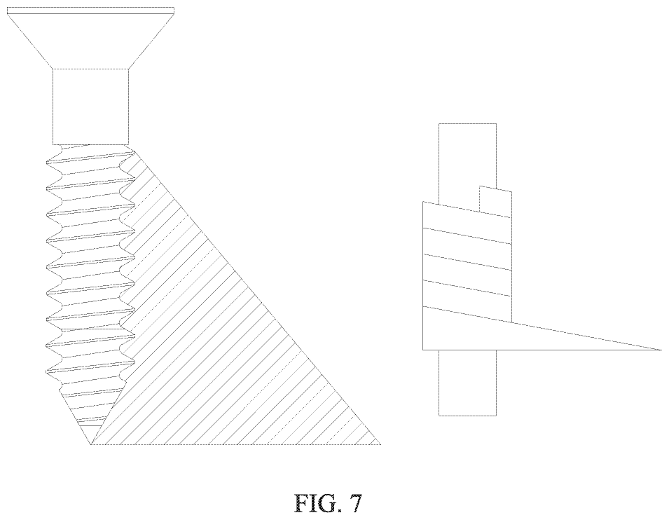

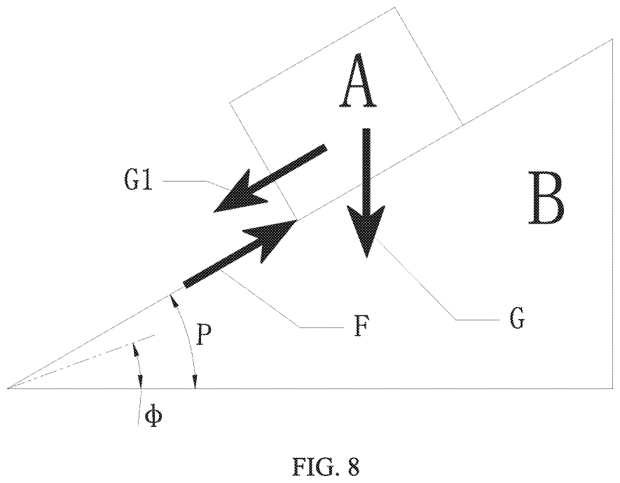

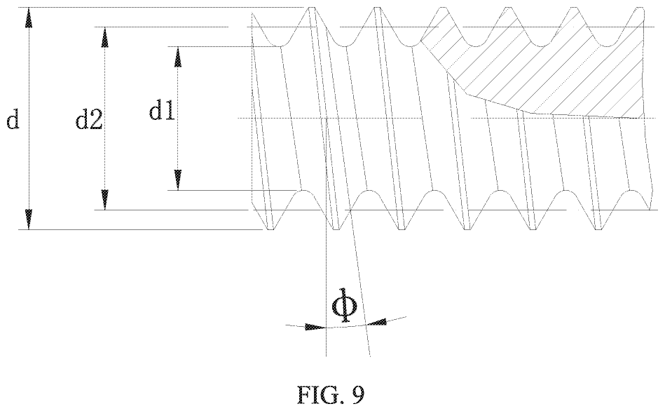

As shown in FIG. 5, the structure, principle and implementation steps of this embodiment are the same as those in embodiment 1. The difference is that the position relationship of the double nuts and the fastened workpiece 130 is different. The double nuts include a nut body 21 and a nut body 22 and the bolt body has a hexagonal head larger than the screw body 31. When the hexagonal head is located at the left side, both of the nut body 21 and the nut body 22 are located at the right side of the fastened workpiece 130. When the bolt and double nut connection structure works, a relationship among the nut body 21, the nut body 22 and the fastened workpiece 130 is a non-rigid connection. The non-rigid connection refers to a fact that the opposite end surfaces of two nut bodies namely the nut body 21 and the nut body 22 are each other's bearing surfaces. The bearing surfaces include a locking bearing surface 111 and a locking bearing surface 112, and mainly applied to non-rigid materials or other non-rigid connection workpieces 130 such transmission members or application fields meeting requirements through installation of double nuts. The workpiece 130 refers to a connected object including the workpiece 130.

The thread work bearing surface in this embodiment is different, including a tapered thread bearing surface 121 and a tapered thread bearing surface 122. When the cylindrical body 2 includes the left nut body 21 and the right nu body 22, the right end surface namely locking bearing surface 111 of the left nut body 21 and the left end surface namely locking bearing surface 112 of the right nut body 22 are in opposite and direct contact and each other's locking bearing surfaces. When the right end surface of the left nut body 21 is the locking bearing surface 111, the right helical conical surfaces of the bidirectional tapered threads 1 of the left nut body 21 and the columnar body 3 namely screw body 31 namely bolt are the thread work bearing surfaces, that is, the tapered hole second helical conical surface 422 and the truncated cone body second helical conical surface 722 are the tapered thread bearing surfaces 122 and the tapered hole second helical conical surface 422 and the truncated cone body second helical conical surface 722 are each other's bearing surfaces. When the left end surface of the right nut body 22 is the locking bearing surface 112, the left helical conical surfaces of the bidirectional tapered threads 1 of the right nut body 22 and the columnar body 3 namely screw body 31 namely bolt are the thread work bearing surfaces, that is, the tapered hole second helical conical surface 422 and the truncated cone body second helical conical surface 722 are the tapered thread bearing surfaces 122 and the tapered hole first helical conical surface 421 and the truncated cone body first helical conical surface 721 are each other's bearing surfaces.

In this embodiment, when the cylindrical body 2 located inside namely the nut body 21 adjacent to the fastened workpiece 130 has been effectively combined with the columnar body 3 namely screw body 31 namely bolt, that is, the internal thread 6 and the external thread 9 constituting the thread connection pair 10 are effectively cohered, the cylindrical body 2 located outside namely the nut body 22 which is not adjacent to the fastened workpiece 130 can kept unchanged and/or disassembled with one nut left (for example, application fields which have requirements on light weigh of equipment or double buts are not needed to ensure the reliability of the connection technology), the disassembled nut body 22 is used as an installation process nut rather than connection nut. Besides being manufactured using the bidirectional tapered thread, the internal thread of the installation process nut is the nut body 22 manufactured using an unidirectional tapered thread and other threads formed by screwing with the tapered thread 1, including a triangular thread, a trapezoidal thread, a sawtooth thread and other non-tapered threads. On the premise of ensuring the reliability of the connection technology, the tapered thread connection pair 10 is a closed-loop fastening technology system, that is, after the internal thread 6 and the external thread 9 of the tapered thread connection pair 10 can be effectively cohered, the tapered thread connection pair 10 will automatically become an independent technical system without relying on the technical compensation of the third party to ensure the technical effectiveness of the connection technology system, that is, even if there are no supports of other objects, including a gap exists between the tapered thread connection pair 10 and the fastened workpiece 130, the effectiveness of the tapered thread connection pair 10 is not affected, which will facilitates significant reduction of the weight of the equipment, removal of the invalid load and promotion of the effective load capability of the equipment, braking performance, energy conservation and emission reduction and other technical requirements, and is a thread technology advantage that is unique when the relationship between the bolt and nut connection structure of the bidirectional tapered thread and the fastened workpiece 130 is non-rigid connection or rigid connection, exclusive of other thread technologies.

In this embodiment, when the hexagonal head of the bolt is located at the right side, both of the nut body 21 and the nut body 22 are located at the left side of the fastened workpiece 130, the structure, principle and implementation steps are similar to those of this embodiment.

### Embodiment 4

As shown in FIG. 6, the structure, principle and implementation steps of this example are similar to those in embodiment 1 and embodiment 3. The difference is that in this embodiment, a spacer such as gasket 132 is added between the nut body 21 and the nut body 22 on the basis of embodiment 3, that is, the right end surface of the left nut body 21 is in opposite and indirect contact with the left end surface of the right nut body 22 via the gasket 132, so as to lock the bearing surfaces with each other, namely, a mutual relationship between the right end surface of the let nut body 21 and the left end surface of the right nut body 22 becomes indirect mutual locking of the support face from direct mutual locking of the support face.

Embodiments of the disclosure are only exemplified for the spirit of the disclosure. Those skilled in the art can make various modifications or supplementations to the described embodiments or use similar manners for replacement, which are not depart from the spirit of the disclosure or go beyond scope defined by the claims.

Although the present application uses terms such as tapered thread 1, cylindrical patent body 2, nut body 21, nut body 22, columnar patent body 3, screw body 31, tapered hole 4, bidirectional tapered hole 41, bidirectional tapered hole conical surface 42, tapered hole first helical conical surface 421, first taper angle α1, tapered hole second helical conical surface 422, second taper angle α2, inner helical line 5, internal thread 6, truncated cone body 7, bidirectional truncated cone body 71, bidirectional truncated cone body conical surface 72, truncated cone body first helical conical surface 721, first taper angle α1, truncated cone body second helical conical surface 722, first taper angle α2, outer helical line 8, external thread 9, olive-like 93, left taper 95, right taper 96, left distribution 97, right distribution 98, thread connection pair and/or thread pair 10, clearance 101, self-locking force, self locking, self positioning, pressure, cone axis 01, thread axis 02, mirror image, shaft sleeve, shaft, single tapered body, dual tapered body, cone, inner cone, tapered hole, outer cone, tapered body, cone pair, helical structure, helical motion, thread body, complete unit thread, axial force, axial force angle, counter-axial force, counter-axial force angle, centripetal force, counter centripetal force, counter collineation, internal stress, bidirectional force, unidirectional force, sliding bearing, sliding bearing pair, locking bearing surface 111, locking bearing surface 112, tapered thread bearing surface 122, tapered thread bearing surface 121, non-entity space, material entity, workpiece 130, nut body locking direction 131, non-rigid connection, non-rigid material, transmission member and gasket 132, but are not exclusive of other terms, use of these terms are only for more conveniently describing and explaining the essence of the disclosure, and explaining them into any additional limitation is contrary to the spirit of the disclosure.

We claim:

1. An olive-shaped bidirectional tapered thread bolt and nut connection structure having a large left taper and a small right taper, namely, a bolt and nut connection structure of an olive-like (left taper is larger than right taper) shaped asymmetrical bidirectional tapered thread, comprising: an external thread (9) and an internal thread (6) which are in mutual thread fit, wherein the complete unit thread of the olive-like (left taper is larger than right taper) shaped asymmetric bidirectional tapered thread (1) is a helical olive-like (93) shaped asymmetric bidirectional tapered body which is large in the middle and small in two ends, has a left taper (95) being larger than a right taper (96) and comprises a bidirectional tapered hole (41) and/or bidirectional truncated cone body (71);
the thread body of the internal thread (6) is presented by the helical bidirectional tapered hole (41) on the inner surface of the cylindrical body (2) and exists in a form of “non-entity space”, and the thread body of the external thread (9) is presented by the helical bidirectional truncated cone body (71) on the outer surface of the columnar body (3) and exists in a form of “material entity”;
the left conical surface of the asymmetric bidirectional tapered body forms the left taper (95) corresponding to a first taper angle (α1), the right conical surface forms the right taper (96) corresponding to a second taper angle (α2), and the left taper (95) and the right taper (96) are opposite in direction and different in taper;
the internal thread (6) and the external thread (9) contain cones in the tapered holes till inner and outer conical surfaces bear each other;
the technical performance mainly depends on the conical surfaces and tapers of the mutually fit threaded bodies, preferably, 0°<first taper angle (α1)<53°, 0°<second taper angle (α2)<53°; for individual special fields, preferably, 53° first taper angle (α1)<180°.

2. The connection structure according to claim 1, wherein the olive-like (93) shaped bidirectional tapered internal thread (6) comprises the left conical surface namely a tapered hole first helical conical surface (421) of the bidirectional tapered hole conical surface (42), a right conical surface namely a tapered hole second helical conical surface (422) of the bidirectional tapered hole conical surface (42), and an inner helical line (5);
a shape formed by the tapered hole first helical conical surface (421) and the tapered hole second helical conical surface (422) namely a bidirectional helical conical surface is the same as a shape of a helical outer flank of a rotating body, wherein the rotating body is formed by two bevels of a right-angled trapezoid union being rotated around a right-angled side of the right-angled trapezoid union, and, at the same time, the right-angled trapezoid union axially moves at a constant speed along a central axis of the cylindrical body (2); wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the cylindrical body (2);
the olive-like (93) shaped bidirectional tapered external thread (9) comprises a left conical surface namely a truncated cone body first helical conical surface (721) of the bidirectional truncated cone body conical surface (72), a right conical surface namely a truncated cone body second helical conical surface (722) of the bidirectional truncated cone body conical surface (72), and an outer helical line (8);
a shape formed by the truncated cone body first helical conical surface (721) and the truncated cone body second helical conical surface (722) namely a bidirectional helical conical surface is the same as a shape of a helical outer flank of the rotating body, wherein the rotating body is formed by the right-angled trapezoid union being rotated around the right-angled side of the right-angled trapezoid union, and, at the same time, the right-angled trapezoid union axially moves at a constant speed along the central axis of the columnar body (3); wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the columnar body (3).

3. The connection structure according to claim 2, wherein when the right-angled trapezoid union rotates a circle at a constant speed, an axial movement distance of the right-angled trapezoid union is at least double a length of the sum of the right-angled sides of the two right-angled trapezoids of the right-angled trapezoid union.

4. The connection structure according to claim 2, wherein when the right-angled trapezoid union rotates a circle at the constant speed, the axial movement distance of the right-angled trapezoid union is equal to a length of the sum of the right-angled sides of the two right-angled trapezoids of the right-angled trapezoid union.

5. The connection structure according to claim 1, wherein the left conical surface and the right conical surface of the bidirectional tapered body, namely the tapered hole first helical conical surface (421), the tapered hole second helical conical surface (422) and the inner helical line (5) are all continuous helical surfaces or discontinuous helical surfaces and/or the truncated cone body first helical conical surface (721), the truncated cone body second helical conical surface (722) and the outer helical line (8) are all continuous helical surfaces or discontinuous helical surfaces.

6. The connection structure according to claim 1, wherein the helical olive-like (93) shaped asymmetrical bidirectional tapered internal thread (6) is formed by oppositely jointing two symmetrical lower bottom surfaces of two tapered holes (4), wherein the two tapered holes have identical lower bottom surfaces and upper top surfaces, but different taper heights; wherein the upper top surfaces of the two tapered holes are located at two ends of the bidirectional tapered holes (41), and are respectively jointed with the upper top surface of the adjacent bidirectional tapered holes;
the helical olive-like (93) shaped asymmetrical bidirectional tapered external thread (9) is formed by oppositely jointing two symmetrical lower bottom surfaces of two truncated cone bodies (7), wherein the two truncated cone bodies have identical lower bottom surfaces and upper top surfaces, but different taper heights; wherein the upper top surfaces of the two truncated cone bodies are located at two ends of the bidirectional truncated cone body (71), and are respectively jointed with the upper top surfaces of the adjacent bidirectional truncated cone bodies (71).

7. The connection structure according to claim 1, wherein when the internal thread (6) and the external thread (9) constitute a thread pair (10), the tapered hole first helical conical surface (421) and the tapered hole second helical conical surface (422) as well as the truncated cone body first helical conical surface (721) and the truncated cone body helical conical surface (722) which are in mutual fit use contact surfaces as bearing surfaces, and the internal and external diameters of the inner cone and the outer cone are centered under the guidance of the helical line till the bidirectional tapered hole conical surface (42) and the bidirectional truncated cone body conical surface (72) are cohered to reach bearing on the helical conical surface in one direction and/or simultaneous bearing on the helical conical surface in two directions and/or till a self locking is generated by fixed-diameter self-positioning contact and/or till fixed-diameter interference contact.

8. The connection structure according to claim 1, wherein the bolt and double nut connection structure is adopted, the double nuts are respectively located at left and right sides of the fastened workpiece and/or the bolt and single nut connection structure is adopted and comprises a single nut (21) being located at the right side or left side of the fastened workpiece and/or the bolt and double nut connection structure is adopted, and the double nuts are both located at the single side of the fastened workpiece; furthermore, when one nut has been effectively combined with the bolt, namely, the internal thread (6) and the external thread (9) constituting the thread connection pair (10) are effectively cohered, the other nut can be disassembled and/or remained, and the disassembled nut is used as an installation process nut whose internal thread comprises a bidirectional tapered thread (1), an unidirectional tapered thread and traditional threads which meet the technical spirit of the disclosure due to mutual thread fit to the bidirectional tapered external thread (9), such as a triangular thread, a trapezoidal thread, a sawtooth thread, a rectangular thread and an arc thread.

9. The connection structure according to claim 1, wherein when the connection hole of the cylindrical body (2) is screwed into the screw-in end of the columnar body (3), the screw-in direction is required, namely, the connection hole of the cylindrical body (2) cannot be screwed in an opposite direction, the connection holes are thread holes formed on the nut (21) and the nut (22), the connection holes are formed in the nut (21) and the nut (22), and the nut refers to an object comprising the nut and having a thread structure on the inner surface of the cylindrical body (2).

10. The connection structure according to claim 1, wherein the internal thread (6) and/or the external thread (9) comprises that a single-pitch thread body is an incomplete tapered geometry, namely, the single-pitch thread body is an incomplete unit thread.
